(19) United States
(12) Patent Application Publication
(10) Pub. No.: US 2018/0375228 A1
(43) Pub. Date: Dec. 27, 2018

(54) Electrical Connector

(71) Applicant: Tyco Electronics (Shanghai) Co. Ltd., Shanghai (CN)

(72) Inventors: Jianfei Yu, Shanghai (CN); Xiang Xu, Shanghai (CN); Hao Wang, Shanghai (CN)

(73) Assignee: Tyco Electronics (Shanghai) Co. Ltd., Shanghai (CN)

(21) Appl. No.: 16/019,758

(22) Filed: Jun. 27, 2018

(30) Foreign Application Priority Data
Jun. 27, 2017 (CN) 201720748446.1

(51) Int. Cl. H01R 4/34; H01R 13/53; H01R 13/24; H01R 13/58; H01R 4/30

(52) U.S. Cl. CPC H01R 4/34; H01R 13/53; H01H 1/5855; H01R 13/5825; H01R 4/305; H01R 13/24

(57) ABSTRACT

An electrical connector comprises a housing formed of an insulating material, a first conductive terminal held in the housing, and a second conductive terminal held in the housing. An air gap is formed between the first conductive terminal and an inner wall of the housing. An internal space is defined among the first conductive terminal, the second conductive terminal, and the housing. The internal space communicates with an outside air through the air gap.

### CROSS-REFERENCE TO RELATED APPLICATION

This application claims the benefit of the filing date under 35 U.S.C. § 119(a)-(d) of Chinese Patent Application No. 201720748446.1, filed on Jun. 27, 2017.

### FIELD OF THE INVENTION

The present invention relates to an electrical connector and, more particularly, to an electrical connector used to transmit power.

### BACKGROUND

Power connectors are commonly used to transmit power. The power connector generally comprises a housing formed of an insulative material and three sheet-like conductive terminals mounted in the housing. The three sheet-like conductive terminals include a first conductive terminal, a second conductive terminal, and a third conductive terminal connected between the first conductive terminal and the second conductive terminal.

In practical applications, a plurality of power connectors are often mounted on the same rail and may be slidable on the rail. The plurality of power connectors abut against each other, which may render an internal space of one power connector defined by the first conductive terminal, the second conductive terminal, and the housing as a closed space isolated from the outside. When energized, large currents may flow through the first, second, and third conductive terminals, and in turn, may cause the first, second, and third conductive terminals to generate a large amount of heat. Since the internal space of the power connector is closed, the generated heat cannot be dissipated to outside of the housing, causing the internal temperature of the power connector to rise and increasing a risk of overheating and fire.

### SUMMARY

An electrical connector comprises a housing formed of an insulating material, a first conductive terminal held in the housing, and a second conductive terminal held in the housing. An air gap is formed between the first conductive terminal and an inner wall of the housing. An internal space is defined among the first conductive terminal, the second conductive terminal, and the housing. The internal space communicates with an outside air through the air gap.

### BRIEF DESCRIPTION OF THE DRAWINGS

The invention will now be described by way of example with reference to the accompanying Figures, of which:

FIG. 1 is an exploded perspective view of an electrical connector according to an embodiment;

FIG. 2 is a perspective view of a first conductive terminal of the electrical connector;

FIG. 3 is a perspective view of a plurality of electrical connectors abutting against each other; and

FIG. 4 is a sectional side view of the electrical connector.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will be thorough and complete and will fully convey the concept of the disclosure to those skilled in the art.

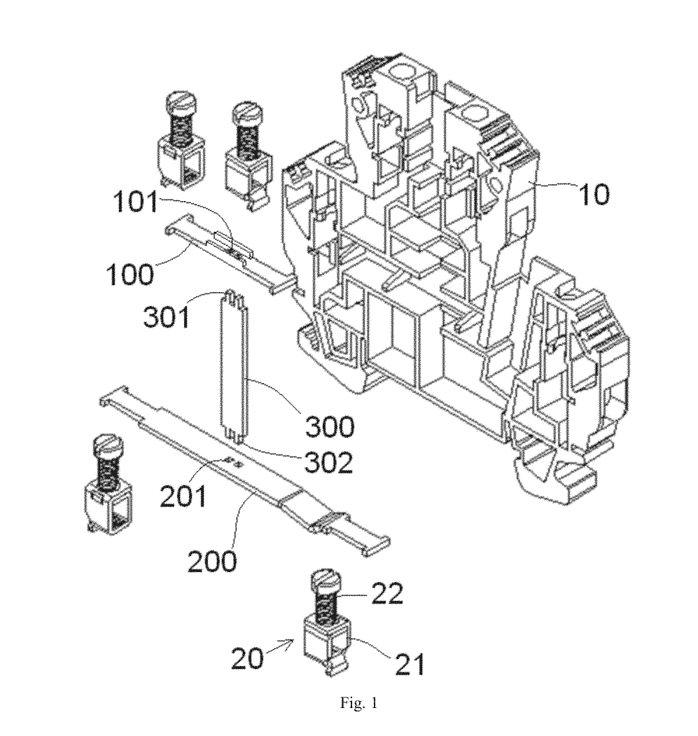

An electrical connector according to an embodiment is shown in FIGS. 1, 3, and 4. The electrical connector comprises a housing 10, a first conductive terminal 100, and a second conductive terminal 200. The housing 10 is formed of an insulating material. The first conductive terminal 100 and the second conductive terminal 200 each have a sheet shape and are held in the housing 10. The first conductive terminal 100 is substantially parallel to the second conductive terminal 200.

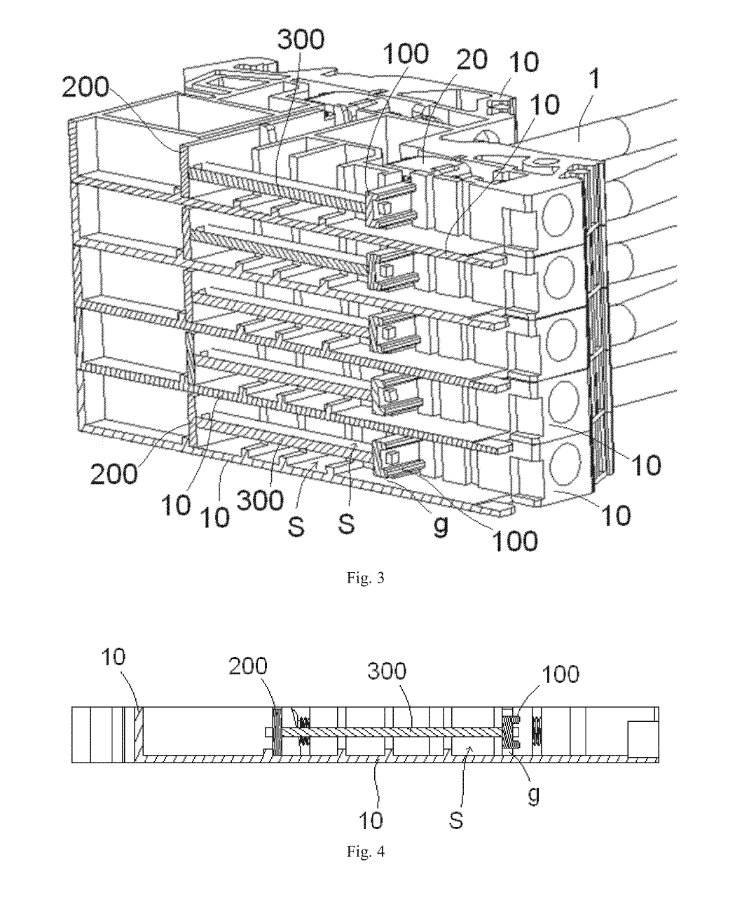

As shown in FIGS. 3 and 4, an internal space S is defined among the first conductive terminal 100, the second conductive terminal 200, and the insulating housing 10. An air gap g is formed between the first conductive terminal 100 and an inner wall of the insulating housing 10, and the internal space S communicates with an outside air through the air gap g, improving heat dissipation of the electrical connector.

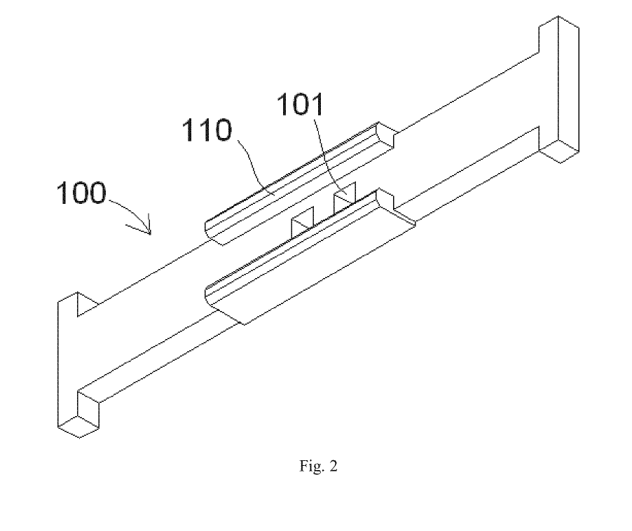

The internal space S, as shown in FIGS. 2-4, is substantially located between a middle portion 110 of the first conductive terminal 100, a middle portion of the second conductive terminal 200, and the insulating housing 10. The air gap g is located between the middle portion 110 of the first conductive terminal 100 and the inner wall of the insulating housing 10.

As shown in FIG. 2, at least a portion of the middle portion 110 of the first conductive terminal 100 has a thickness greater than that of other portions of the first conductive terminal 100. The middle portion 110 of the first conductive terminal 100 has a width equal to that of the other portions of the first conductive terminal 100, such that an electrically conductive cross-sectional area of the middle portion 110 of the first conductive terminal 100 is greater than that of the other portions of the first conductive terminal 100. In an embodiment, the middle portion 110 is formed by stamping to increase a thickness thereof; before the stamping, the thickness of the middle portion 110 of the first conductive terminal 100 is equal to that of the other portions of the first conductive terminal 100.

The electrical connector, as shown in FIGS. 1, 3, and 4, further comprises a third conductive terminal 300 held in the insulating housing 10 and connected between the first conductive terminal 100 and the second conductive terminal 200. As shown in FIGS. 3 and 4, the third conductive terminal 300 is located in the internal space S. The third conductive terminal 300 has a first end connected to the middle portion 110 of the first conductive terminal 100 and a second end 302 connected to a middle portion of the second conductive terminal 200. As shown in FIG. 1, each of the first and second ends 301, 302 of the third conductive terminal 300 is formed with a pin portion, and the middle portions of the first conductive terminal 100 and the second conductive terminal 200 are formed with insertion holes 101, 201 into which the pin portions of the first and second ends 301, 302 of the third conductive terminal 300 are inserted, respectively.

The electrical connector, as shown in FIGS. 1 and 3, further comprises a clamping member 20 held in the insulating housing 10 and adapted to clamp an end of a wire 1 inserted into the insulating housing 10 to an end of the first conductive terminal 100 or the second conductive terminal 200, so that the wire 1 is electrically connected with the first conductive terminal 100 or the second conductive terminal 200. The clamping member 20 comprises a clamping holder 21 and a screw 22. The clamping holder 21 is sheathed on the end of the first conductive terminal 100 or the second conductive terminal 200. The end of the wire 1 extends into the holder 21, the screw 22 is screwed to the clamping holder 21, and the end of the wire 1 is pressed together with the end of the first conductive terminal 100 or the second conductive terminal 200, so that the wire 1 is electrically connected with the first conductive terminal 100 or the second conductive terminal 200.

In an embodiment, the electrical connector is a power connector. As shown in FIG. 3, a plurality of power connectors may be mounted on the same rail, slid on the rail, and abut against each other. In the shown embodiment, when the plurality of power connectors abut against each other, the internal space S of each power connector communicates with the outside air through the air gap g as described above, improving heat dissipation effect of the power connectors. Thus, it is possible to prevent the power connector from being overheated.

What is claimed is:

1. An electrical connector, comprising:
a housing formed of an insulating material;
a first conductive terminal held in the housing, an air gap is formed between the first conductive terminal and an inner wall of the housing; and
a second conductive terminal held in the housing, an internal space is defined among the first conductive terminal, the second conductive terminal, and the housing, the internal space communicating with an outside air through the air gap.

2. The electrical connector of claim 1, wherein the internal space is defined among a middle portion of the first conductive terminal, a middle portion of the second conductive terminal, and the housing.

3. The electrical connector of claim 2, wherein the air gap is defined between the middle portion of the first conductive terminal and the inner wall of the housing.

4. The electrical connector of claim 3, wherein the middle portion of the first conductive terminal has a thickness greater than a thickness of a plurality of other portions of the first conductive terminal.

5. The electrical connector of claim 4, wherein the middle portion of the first conductive terminal has a width equal to a width of the other portions of the first conductive terminal.

6. The electrical connector of claim 5, wherein an electrically conductive cross-sectional area of the middle portion of the first conductive terminal is greater than an electrically conductive cross-sectional area of the other portions of the first conductive terminal.

7. The electrical connector of claim 6, wherein the middle portion of the first conductive terminal is formed through a stamping to increase the thickness of the middle portion, and the thickness of the middle portion is equal to the thickness of the other portions of the first conductive terminal before the stamping.

8. The electrical connector of claim 2, further comprising a third conductive terminal held in the housing and connected between the first conductive terminal and the second conductive terminal.

9. The electrical connector of claim 8, wherein the third conductive terminal is disposed in the internal space.

10. The electrical connector of claim 8, wherein the third conductive terminal has a first end connected to the middle portion of the first conductive terminal and a second end connected to the middle portion of the second conductive terminal.

11. The electrical connector of claim 10, wherein the first end and the second end of the third conductive terminal are each formed as a pin portion.

12. The electrical connector of claim 11, wherein the middle portions of the first conductive terminal and the second conductive terminal are each formed with insertion holes into which the pin portions of the first end and the second end of the third conductive terminal are inserted.

13. The electrical connector of claim 8, further comprising a clamping member held in the housing and adapted to clamp an end of a wire inserted into the housing on an end of the first conductive terminal or the second conductive terminal and electrically connect the wire with the first conductive terminal or the second conductive terminal.

14. The electrical connector of claim 13, wherein the clamping member comprises a clamping holder sheathed on the end of the first conductive terminal or the second conductive terminal and a screw.

15. The electrical connector of claim 14, wherein the end of the wire extends into the clamping holder, the screw is screwed to the clamping holder, and the end of the wire is pressed together with the end of the first conductive terminal or the second conductive terminal.

16. The electrical connector of claim 1, wherein the electrical connector is a power electrical connector.
